(19) United States
(12) Patent Application Publication
(10) Pub. No.: US 2013/0060535 A1
(43) Pub. Date: Mar. 7, 2013

(54) DATA MODEL FOR THE DESCRIPTION OF A COMPONENT TO BE MANUFACTURED BY USING A LAYERED CONSTRUCTION METHOD

(71) Applicant: CARL FRUTH, PARSBERG (DE)

(72) Inventor: CARL FRUTH, PARSBERG (DE)

(73) Assignee: FIT-FRUTH INNOVATIVE TECHNOLOGIEN GMBH, PARSBERG (DE)

(21) Appl. No.: 13/600,548

(22) Filed: Aug. 31, 2012

(30) Foreign Application Priority Data
Aug. 31, 2011 (DE) 10 2011 111 541

(51) Int. Cl. G06F 17/50

(52) U.S. Cl. 703/1

(57) ABSTRACT

A data model describes a component to be produced by way of a layer building process. In order to avoid distortion of the component, a partitioning of the component into three-dimensional volume regions is proposed, the regions encompassing more than one build layer and the external surfaces thereof extending by preference obliquely to the build direction, with the result that superimposed adjacent layers of the 3D volume region exhibit different cross-sectional areas.

The invention relates to the sector of additive fabrication methods. More precisely, the invention relates to a data model for describing a component to be manufactured with the aid of a layer building method. The invention moreover relates to a method for layered building of a component using such a data model. Lastly, the invention also relates to a layer manufacturing system that is embodied for carrying out this method, and to a computer program for such a layer manufacturing system.

Layer manufacturing methods serve to manufacture components from solidifiable material, such as resin, plastic, metal, or ceramic, applied in layers, and are used e.g. for the fabrication of engineering prototypes. A component of this kind is also referred to as a “shaped element,” or in general as an “object.” Systems with which a layer manufacturing method of this kind is carried out are also referred to as “rapid prototyping” systems.

In an additive fabrication method of this kind, layers of a build material are applied successively over one another. Before application of the respective subsequent layers, those points in the respective layers which correspond to the cross section of the object to be fabricated are selectively solidified. Solidification occurs, for example, by local heating of a powdered layer raw material with the aid of a radiation source. Controlled introduction of radiation in suitable fashion into the desired regions allows an exactly defined object structure of any nature to be generated.

Radiation energy for solidifying the build material is introduced, for example, with the aid of a deflectable laser beam. An additive method of this kind is usable in particular for manufacturing three-dimensional objects, by successively generating thin, individually configured layers. A variety of additive fabrication methods based on the principle of layer building, and systems for carrying them out, are known from the existing art, for example stereolithography, selective laser melting, selective mask sintering, fused deposition molding, PolyJet, 3D printing, etc.

In the context of layered building of components with the aid of additive fabrication methods, stresses occur upon cooling and curing of the build materials, and can result in deformation of individual layers and thus in distortion of the component. This has a disadvantageous effect on the dimensional consistency of the component, and can cause the layered construction to break off

A variety of actions for minimizing material shrinkage during building are known from the existing art. For this purpose, an attempt is made to locally limit the occurrence of stresses by subdividing individual layers into smaller two-dimensional layer regions that are successively solidified or fused in order to reduce stress. Layer regions of this kind are also referred to as “regions” or “partitions.” In other words, the division into regions that occurs in the context of this “layer partitioning” is always layer-oriented. The perspective is always two-dimensional (2D view). Because an (albeit very small) layer thickness exists in reality, the term “2.5D view” is also used.

Energy delivery into these layer regions occurs, for example in the context of laser melting, by the fact that the laser beam performs a line-by-line scan of the relevant surface region in linear fashion, i.e. forming closely adjacent rectilinear hatching lines, in order to consolidate the layer region. It is known to vary this hatching pattern or exposure pattern, in particular the hatching direction, from one layer to another or even from one layer region to another, in order to avoid the creation of preferred directions that might result in material distortion in the context of fabrication. A regular offset of the two-dimensional regions from one layer to another, in order to generate an overlap with respectively adjacent layers, is also known. The aforesaid actions are sufficiently successful for individual method/material combinations. With others they do not produce the desired success.

An object of the present invention is to reduce the occurrence of component distortion. This object is achieved respectively by a data model according to claim 1 and by a method according to claim 4 and by a layer manufacturing system according to claim 6 and by a computer program according to claim 7.

The advantages and embodiments explained below in connection with the data model also apply mutatis mutandis to the method according to the present invention and to a layer manufacturing system embodied to carry out the method with the aid of the data model, and vice versa. Advantageous embodiments of the invention are indicated in the dependent claims.

All known approaches to achieving the object consider the problem from one layer to another, and generate substantially planar layer regions perpendicular to the build direction. The exposed edges of these regions are always located parallel to the build direction. The essential stresses therefore occur (albeit in reduced fashion) parallel to the build direction. This results in distortion in the component.

The invention fundamentally retains the principle of layer-by-layer building of the component. What occurs, however, is a division, not linked to individual layers (i.e. multiple-layer in nature), of the object into 3D volume regions; these are to be understood as “genuine” three-dimensional volume regions, and are freely definable volumes rather than, for example, identically shaped cubes or voxels oriented parallel to the build direction. In other words, a division of the component into multiple-layer volume regions takes place. In individual cases, an individual volume region can also encompass only one single layer. Usually, however, a volume region extends over several layers. Instead of the known layer partitioning or cube partitioning known from the existing art, what occurs is thus a layer-independent volume partitioning of the entire object. Within individual build layers in turn, a division into regions within a layer can of course additionally occur.

According to the present invention, control data that are generated on the basis of, or in consideration of, this kind of volume partitioning of the object are therefore generated in order to control the layer manufacturing system. The control data encompass a corresponding data model for describing the component to be manufactured, or are generated with the use of such a data model.

The data model according to the present invention for describing a component to be manufactured with the aid of a layer building method is notable for the fact that the data model describes an at least partial division of the component into a number of volume regions, at least one volume region encompassing more than one build layer.

Stated differently, the data module describes a component divided into a number of volume regions, at least one of the volume regions partly or entirely encompassing two or more mutually adjacent build layers. In other words, the data describe the component independently of build layers and in multiple-layer fashion with the aid of three-dimensional volume regions. The result is the component is subdivided into volume regions, each of which encompasses at least parts of at least two adjacent layers.

The method according to the present invention for layered building of a component is notable for the fact that at least one building step occurs indirectly or directly with the use of a data model according to claims 1 to 3. This means that layered building, in particular material application and/or solidification of the build material, occurs according to the above-described data model, or that layered building occurs with the use of control data that were generated on the basis of the data model.

The layer manufacturing system according to the present invention is notable for the fact that is embodied to carry out the method according to claim 4.

The computer program according to the present invention for carrying out the method according to claim 4 and/or for controlling a layer manufacturing system according to claim 6 is notable for computer program instructions for at least partial division of a component, to be manufactured with the aid of a layer building method, into a number of 3D volume regions, at least one 3D volume region encompassing more than one build layer, and/or for generation of a data model according to one of claims 1 to 3 when the computer program is executed on a computer.

The data model and/or the control data are advantageously usable in a universally usable standardized data format that is independent of the build method selected.

All computing operations necessary in conjunction with the generation of the data model, the generation of control data for a layer manufacturing system or for carrying out the method according to the present invention, or for controlling the layer manufacturing system, are executed by one or more data processing units that are embodied to carry out said operations. Each of these data processing units preferably comprises a number of functional modules, each functional module being embodied to carry out a specific function or a number of specific functions in accordance with the methods described. The functional modules can be hardware modules or software modules. In other words, the invention, to the extent it relates to the data processing unit, can be implemented either in the form of computer hardware or in the form of computer software or in a combination of hardware and software. To the extent the invention is implemented in the form of software, i.e. as a computer program product, all functions described are realized by way of computer program instructions when the computer program is executed on a computer having a processor. The computer program instructions are implemented in this context in a manner known per se in any desired programming language, and can be made available to the computer is any desired form, for example in the form of data packets that are transferred via a computer network, or in the form of a computer program product stored in a diskette, a CD-ROM, or another data medium.

In summary, the following may be stated: The present invention departs from the conventional two-dimensional, layer-referred point of view. Instead of breaking down a component layer into different regions within the individual layer, the component as a whole is divided into several irregular three-dimensional regions that preferably differ from one another (3D partitioning). The result is preferably to yield exposed edges and surfaces obliquely to the build direction. The fact that the interfaces of the volume regions extend obliquely to the build direction yields cross sections that are different from one layer to another, for example having a different size and/or shape. The process of building each layer of the completed component is thus, as a rule repeatedly interrupted because of the construction of the individual volume regions. Because of the oblique position of the interfaces, the interruption in layer building occurs preferably at spacings that differ from one layer to another, and preferably at irregular spacings within the layer. The result is a division and deflection of stresses within the component.

Because free stresses are conveyed in different spatial directions, the creation of preferred directions is very greatly reduced. Fewer stresses that result in geometrical changes are therefore produced upon component production. At the same time, the stress distribution within the overall component changes. By means of a corresponding configuration of the neighboring volume regions (offsets, overlapping regions, gaps, etc.), the stresses proceeding from individual volume regions are absorbed and transmitted without resulting in an amplification of stresses; or a compensation of stresses occurs. The result is that this leads to stress homogenization in the component, which minimizes distortion in the component. It is therefore also possible to use novel build materials that could not hitherto be utilized. Building with the aid of additive fabrication methods can occur with higher accuracy or else at greater speed.

In a departure from those build techniques in which identically shaped cubes or voxels oriented parallel to the build direction are used, the 3D volume regions of the present invention are freely definable. This means on the one hand that the 3D volume regions constituting the component are preferably different from one another. It means on the other hand that each of the 3D volume regions is preferably irregular in shape. In other words, no symmetrically extending and/or repeating shapes preferably occur within a volume region.

In order to avoid stresses within the component during fabrication, in a particularly preferred embodiment of the invention the data model that is used describes the division into volume regions in such a way that at least one of the volume regions has an external surface extending obliquely to the build direction. This means that at least one of the layers of a volume region has an external or peripheral surface that extends obliquely to the build direction. Preferably, however, a plurality of the layers of a volume region have external or peripheral surfaces that extend obliquely to the build direction. “Obliquely to the build direction” means in this context that the external surface does not extend perpendicular to the build direction, but instead lies obliquely in space. An external surface of this kind defines, as an interface, either the boundary of a layer or a layer sub-region, or the boundary of a volume region with an adjacent layer, with an adjacent layer sub-region, or with an adjacent volume region. Or the external surface defines the external boundary of the component, or the boundary of the component interior with respect to the component surface.

The conformation of the interfaces obliquely to the build direction serves to discharge obliquely directed stresses to adjacent volume regions. By preference, substantially all the volume regions have at least one external surface extending obliquely to the build direction. It is very particularly advantageous if this is the case for substantially all external surfaces.

An “oblique position” of an external surface means that superimposed adjacent layers of a volume region exhibit different cross-sectional areas. Expressed differently, the component is divided into volume regions having cross-sectional areas that change in the build direction. In the case of a volume region encompassing several layers, which region comprises in each layer plane at least one sub-region of a layer, this means that the boundary of the volume region preferably constantly continues out beyond a layer into one or more adjacent layers. The result is that each layer of the completed component is constituted from a number of sub-regions of different shapes and different sizes. At the same time, sub-regions located above one another in adjacent layers also differ in terms of shape and size.

The stresses occurring in the context of component production during curing or solidification of the build material are conveyed at least in part in different directions, preferably in all three spatial dimensions. The result is ultimately that these stresses, and the component distortion associated therewith, are eliminated or considerably reduced. This is achieved according to the present invention by the fact that the volume regions are selected in such a way that the free stresses at the partition boundaries are oriented obliquely to the build direction. As a result, the stress vectors point in a plurality of different directions. This produces a distribution and/or partial extinction of the stresses. Remaining stresses are preferably absorbed to a decreased extent, but in any event not in amplified fashion, by adjacent volume regions. These adjacent volume regions are likewise optimized in terms of stress behavior, i.e. likewise have external surfaces that are embodied with an eye toward optimum absorption and transmission of stresses. The result is an at least partial compensation for the stresses, considered over the volume regions of the component.

The size and shape of the volume regions, and in particular the conformation of the external surfaces of the volume regions, are optimized in such a way that the stresses resulting after completion of the component are minimal.

For this, the volume regions exhibit, for example, a three-dimensional offset. This kind of offset of at least one volume region serves to generate an overlap region or a gap between at least two volume regions. The three-dimensional offset preferably has a different size in different spatial directions. If volume regions at least partly overlap, provision is made in an embodiment of the invention for repeated energy input into the overlapping regions, so that the relevant build material is repeatedly solidified. The repeated solidification causes the density of the material in those regions to change. The volume regions can, however, also be provided in a manner spaced apart from one another, so that they are separated from one another by gaps or the like. Gaps and/or overlap regions can, however, also in turn be defined as separate independent volume regions. The offset of individual volume regions can be different depending on geometrical proximity relationships between mutually adjacent volume regions.

In a further embodiment of the invention, at least one volume region is completely covered by an overlap of another volume region.

The definition of the volume regions, and thus the partitioning of the component, occurs preferably at least also in consideration of geometrical parameters of the component to be fabricated. The partitioning can also, however, be calculated with the use of analytical, computed parameters. Another possibility is to calculate the partitioning using measured values or sensor values at run time during building, for example using measured values for distortion stress at one or measurement points of the component. It is likewise possible to calculate the partitioning using evaluated measured values or sensor values, subsequently to building, for a following build. Partitioning can also, however, be computed by way of a simulation. Lastly, it is likewise possible to calculate the partitioning randomly. It is moreover possible for several of the above-described methods for defining the volume regions to be combined with one another.

The partitioning is advantageously also used for the calculation of auxiliary constructions, for example to calculate support structures for supporting specific regions, in particular projecting regions of the component, or for calculating reinforcements of such a supporting construction.

The data model of the component to be manufactured encompasses, with the indications as to the volume regions, descriptive data of the component geometry. In a further preferred embodiment of the invention, the data model defines at least one build parameter for each volume region. The data for each layer or each layer segment within a volume region preferably define at least one build parameter.

The at least one build parameter is, in particular, one or more parameters relating to the solidification of the build material. The nature of the material application and/or solidification is thus particularly influenced by this parameter.

For example, the sequence of the volume regions to be solidified is defined by the build parameter or parameters. It is thus possible, for example, for the construction of the component in terms of volume regions to occur in such a way that individual volume regions are constructed layer by layer in succession. Expressed differently, in particular when selectively material-applying additive fabrication methods are used, individual volume regions can also be built up over several layers before further volume regions are built, likewise over several layers.

Alternatively to this, a build parameter can also stipulate that the volume regions are built simultaneously. In this case, respectively corresponding layers of several volume regions are solidified simultaneously.

In an embodiment of the invention, a build parameter stipulates a specific fill pattern (e.g. hatching) for each volume region or each individual layer of a volume region. In a further embodiment of the invention, at least one volume region has a fill pattern differing from another volume region. In a further embodiment, at least one volume region is occupied by one and the same fill pattern over several layers. In a further embodiment, different volume regions are occupied by different fill patterns. In a further embodiment, at least one volume region is occupied by a fill pattern differing layer by layer.

For example, it has proven advantageous to define fill patterns in such a way that long straight lines do not occur, since they can bring about high stresses during component fabrication. Depending on the application, fill pattern lines describable only with the aid of vectors are therefore not used. Fill patterns in which dynamic energy inputs occur, depending on the build material used, in spot-shaped or planar areas are also utilized. In this case specific spots or areas in the layer to be solidified are traveled to, and energy input then occurs during a defined dwell time during which the radiation intensity or energy input quantity can at the same time be varied. Be it noted in this connection that the invention is also usable with build methods in which solidification occurs not by means of a laser that describes spots or lines, but instead by means of areal irradiation of the build material or by means of selective material application.

In an embodiment of the invention, a build parameter describes the energy input and thus defines different solidification energies, for individual layers or in multiple-layer fashion, for each volume region. In a further embodiment, a build parameter also defines the use of a specific radiation source, available for selection, for material solidification.

In an embodiment of the invention, a build parameter stipulates the use of a specific build material for a portion of the volume region or for the entire volume region, so that different materials are utilized within the component or within a volume region.

In a further embodiment of the invention, a build parameter specifies, for each volume region or each individual layer of a volume region, a specific material density and/or layer thickness, i.e. influences the manner in which material to be solidified is applied in layers.

In a further embodiment of the invention, a build parameter stipulates the build direction of the volume regions to be solidified.

All the aforesaid build parameters can be used, individually or in any combination with one another, depending on the particular application and the desired properties of the component to be manufactured. Depending on the additive fabrication method being used or depending on the desired result, the build parameters can be selected algorithmically, randomly, or in a manner influenced by measured data or sensor data, or can be calculated analytically or by simulation. For example, selection of a specific fill pattern from a number of possible predefined fill patterns, or the calculation of a new fill pattern for a volume region or for a portion of a volume region, occurs with the use of measured values or sensor values obtained e.g. by measuring the distortion stress. The fill pattern can, however, also be selected or calculated using results of a simulation or of an analytical calculation.

Both partitioning and the definition of the build parameters for the individual volume regions always occur from the standpoint of avoiding or reducing material stresses, material distortion, or other undesired deformations of the component. At the same time, a large number of possibilities arise therefrom for exerting controlled influence on properties of the component to be manufactured, for example on mechanical or structural properties. For example, the internal structure of the component can be influenced in controlled fashion by deliberately varied energy inputs and/or volume regions of differing density.

In a further preferred embodiment of the invention, the data model describes a division of the component interior into a number of volume regions, and a separate division of the component surface into a number of volume regions.

A separate division of the component surface, i.e. one independent of the division of the component interior, in order to achieve a stress-reducing configuration not only makes it possible to describe the component surface by means of a data model independently of the component interior and, with the aid of the corresponding data model, to carry out building of the component surface independently of the component interior. Mutually independent and separate (but mutually coordinated) partitioning also makes possible optimized configuration of adjacent volume regions in order to transmit and absorb the residual stresses. Interface optimization for stress reduction is thus possible not only for the component interior, but also, independently thereof, for the component surface.

An exemplifying embodiment of the invention will be explained in further detail below with reference to the drawings, in which:

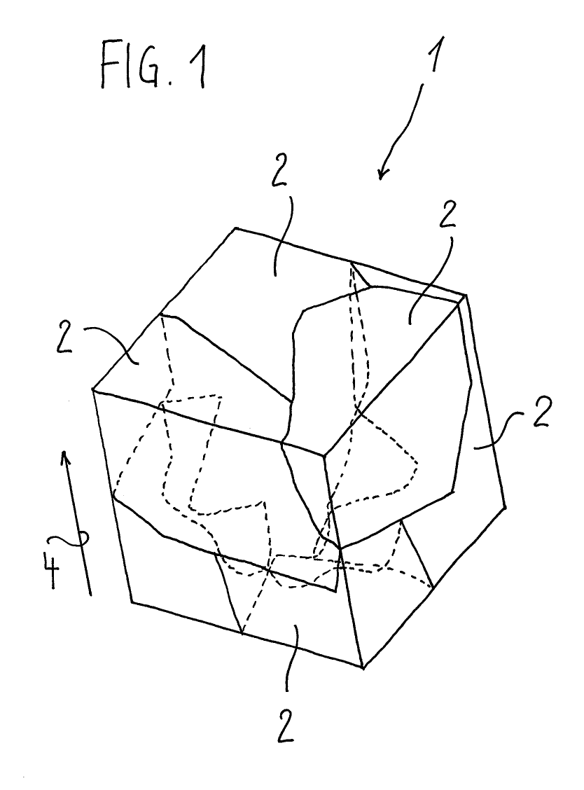

FIG. 1 is a perspective view of a cube-shaped portion of a first component having several volume regions,

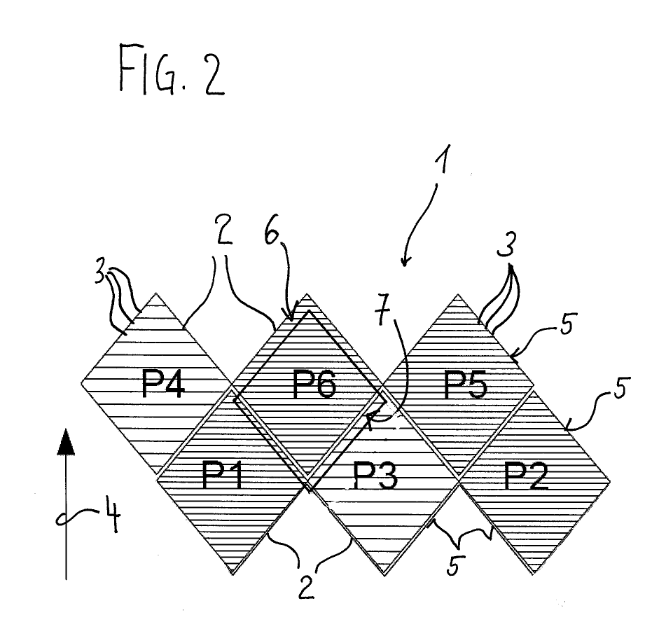

FIG. 2 is a section through part of a second component having several volume regions.

All the Figures show the invention merely schematically and with its essential constituents. Identical reference characters refer therein to elements of identical or comparable function.

Using a data model previously generated with the aid of a computer program, optionally with the use of measured data or sensor data, control data for controlling a layer manufacturing system are generated in a control unit of the layer manufacturing system. The layer manufacturing system to which control is applied using said control data generates, in the context of execution of a layer building method, a component 1 described by the data model.

The data model used describes a complete division of component 1 into a number of 3D partitions 2, at least one 3D partition 2 encompassing more than one build layer 3. At least one of 3D partitions 2 has an external surface 5 extending obliquely to build direction 4. The data model defines at least one build parameter for each 3D partition 2.

The building of component 1 by the layer manufacturing system occurs in accordance with this component description.

The method according to the present invention is notable for the fact that component 1 is built so as to constitute multiple-layer volume regions 2 whose external surfaces 5 extend obliquely to build direction 4. The result is that superimposed adjacent layers 3 of each of these volume regions 2 exhibit different cross-sectional areas, in such a way that stresses produced in the context of component production are conveyed at least in part in different directions.

FIG. 1 depicts in perspective, by way of example, a cube-shaped portion of a real first component 1 having several irregular partitions 2 that differ from one another.

FIG. 2 is a section through part of a notional second component 1 having several partitions 2. For illustrative purposes, a simplified, regular division of component 1 into partitions 2 is depicted.

As is apparent from the illustration, each partition 2 encompasses several build layers 3, the thickness of build layers 3 of partitions P3, P4 being greater than the thickness of build layers 3 of the other partitions P1, P2, P5, and P6. As a result of the specific shape, shown here by way of example, of partitions 2, the embodiment illustrated makes possible an almost unrestrictedly selectable build sequence in which partitions 2 can be built successively in groups. Partitions 2 are built successively, layer by layer in each case, in the sequence P1 to P6; firstly group P1, P2, P3 is built, and then group P4, P5, P6. Different build parameters can be used for each layer 3 and/or each partition 2 in the context of the building of partitions 2.

An offset of partitions allows the formation of gaps 6 and overlap regions 7, which can be irradiated repeatedly during the solidification step. An offset of partition 6 is depicted by way of example in FIG. 2.

If the data model used is one that describes, in addition to a division of the component interior into a number of 3D partitions, a division of the component surface into a number of 3D partitions, both the component shell (not depicted) and the component interior can be built in stress-optimized fashion.

All features presented in the description, in the claims which follow, and in the drawings may be essential to the invention both individually and in any combination with one another.

### LIST OF REFERENCE CHARACTERS

1 Component
2 Volume region
3 Layer
4 Build direction
5 External surface
6 Gap
7 Overlap region

1-7. (canceled)

8. A data model for describing a component to be manufactured by way of a layer building process, comprising:
the data model describing an at least partial division of the component into a plurality of 3D volume regions, with at least one of the 3D volume regions encompassing more than one build layer and including an exterior surface extending obliquely to the building direction;
wherein superimposed adjacent layers of the 3D volume region exhibit different cross-sectional areas in such a way that stresses occurring upon component production are conveyed, at least in part, in mutually different directions.

9. The data model according to claim 8, wherein the data model defines at least one build parameter for each 3D volume region, the build parameter being at least one of a fill pattern or an energy input.

10. The data model according to claim 8, wherein the data model describes a division of a component interior into a plurality of 3D volume regions, and a separate division of the component surface into a plurality of 3D volume regions.

11. A method for building of a component in a layer building process, the method which comprises:
providing a data model describing the component with an at least partial division of the component into a plurality of 3D volume regions, with at least one of the 3D volume regions encompassing more than one build layer and including an exterior surface extending obliquely to the building direction, and with superimposed adjacent layers of the 3D volume region exhibiting different cross-sectional areas in such a way that stresses occurring upon component production are conveyed, at least in part, in mutually different directions; and
carrying out at least one building step indirectly or directly with the use of the data model describing the component.

12. The method according to claim 11, which comprises building up individual 3D volume regions over several build layers prior to building further 3D volume regions, likewise over several build layers.

13. A layer manufacturing system for layered building of a component, configured to carry out the method according to claim 11.

14. A computer program product, comprising:
computer-executable code stored in non-transitory form and configured for carrying out a method for building a component in a layer building process, and/or for controlling a layer manufacturing system for building a component in a layer building process;
the computer-executable code including program instructions configured for carrying out at least one of the following steps when the computer program is executed on a computer:
at least partially dividing a component, to be manufactured by way of a layer building process, into a number of 3D volume regions, with at least one 3D volume region encompassing more than one build layer of the layer building process and including an exterior surface extending obliquely to a building direction, such that superimposed adjacent layers of the 3D volume region exhibit different cross-sectional areas in such a way that stresses occurring upon component production are conveyed at least in part in mutually different directions;
or
generating a data model describing the component with an at least partial division of the component into a plurality of 3D volume regions, with at least one of the 3D volume regions encompassing more than one build layer and including an exterior surface extending obliquely to the building direction, and with superimposed adjacent layers of the 3D volume region exhibiting different cross-sectional areas in such a way that stresses occurring upon component production are conveyed, at least in part, in mutually different directions.
